(19) United States
(12) Patent Application Publication
(10) Pub. No.: US 2026/0257734 A1
(43) Pub. Date: Sep. 3, 2026

(54) UNDERBODY COLLISION PREVENTION ASSEMBLY FOR VEHICLE

(71) Applicant: HCL Technologies Limited, New Delhi (IN)

(72) Inventors: Srinivasan R, Chennai (IN); Sridhar S, Chennai (IN); Raghuraman G, Chennai (IN)

(21) Appl. No.: 19/312,379

(22) Filed: Aug. 28, 2025

(30) Foreign Application Priority Data
Feb. 28, 2025 (IN) 202511017909

(51) Int. Cl. B62D 25/20

(52) U.S. Cl. CPC B62D 25/2072

(57) ABSTRACT

An underbody collision prevention assembly for a vehicle is disclosed. The assembly includes a pair of support brackets configured to be fixated to a long run of a portion of a chassis in the underbody of the vehicle. The assembly includes a plurality of shafts accommodated within the pair of support brackets. The assembly includes a roller equipped on each shaft. The roller is configured to roll about a central axis on an obstacle on a road upon a contact of the underbody with the obstacle.

### DESCRIPTION

### TECHNICAL FIELD

This disclosure relates generally to the field of automobiles or vehicles, more particularly to an assembly for preventing underbody collision of the vehicle.

### BACKGROUND

Vehicles operating on roads are susceptible to various forms of damage, such as scraping, suspension damage, fluid leaks, battery impairment, and the like, primarily due to elevated speed breakers and unexpected obstacles such as road bumps, and speed breakers. Particularly, an underbody of the vehicle is vulnerable to such damages, due to lack of adequate protective measures. Nevertheless, the obstacles may be detected, and the speed may be decelerated upon detection of the obstacles, but the risk of underbody collision with the obstacle remains intact.

Additionally, the underbody may be a lower section of a vehicle frame and may be configured to protect vital components like an engine, suspensions, and exhaust system installed on a chassis of the vehicle. Further, the underbody may contribute to the structural integrity, safety, and rigidity of the chassis of the vehicle. Accordingly, the vital components are at risk of damage when the underbody collides with the obstacles exceeding a ground clearance of the vehicle. Therefore, such damages encompass the potential for degradation of the underbody and an increase in maintenance costs borne by an owner of the vehicle due to the continual degradation of the underbody.

Accordingly, there is a requirement for a solution to prevent collision of the underbody of the vehicle with the obstacle on the road.

### SUMMARY

In an embodiment, an underbody collision prevention assembly is disclosed. The assembly may include a pair of support brackets configured to be fixated to a long run of a portion of a chassis in the underbody of the vehicle. The assembly may include a plurality of shafts accommodated within the pair of support brackets. The assembly may further include a roller equipped on each shaft. Further, the roller is configured to roll about a central axis on an obstacle on a road upon a contact of the underbody with the obstacle.

In another embodiment, a method of retrofitting an underbody collision prevention assembly to a vehicle is disclosed. The method may include adjoining, a pair of support brackets to a long run of a chassis of the vehicle. Further, each support bracket may be configured to accommodate a plurality of shafts and each shaft is equipped with a roller. Furthermore, the roller may be configured to roll about a central axis on an obstacle on a road upon a contact of the underbody with the obstacle.

In another embodiment, a chassis is disclosed. The chassis may include an underbody collision prevention assembly. The chassis may include a long run of a portion of the chassis in an underbody of the vehicle. The chassis may include a pair of support brackets configured to be fixated to the long run. The chassis may include a plurality of shafts accommodated within the pair of support brackets. The chassis may further include a roller equipped on each shaft. Further, the roller is configured to roll about a central axis on an obstacle on a road upon a contact of the underbody with the obstacle.

In yet another embodiment, a vehicle is disclosed. The vehicle may include a chassis and an underbody collision prevention assembly fixated to the chassis. The vehicle may include a pair of support brackets configured to be fixated to a long run of a portion of the chassis in the underbody of the vehicle. The vehicle may include a plurality of shafts accommodated within the pair of support brackets. The vehicle may further include a plurality of rollers mounted on the plurality of shafts. Further, the plurality of rollers is configured to roll about a central axis on an obstacle on a road upon a contact of the underbody with the obstacle.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a bottom view of an underbody of a vehicle, in accordance with an embodiment of the present disclosure.

FIG. 2 illustrates a first-front view of an underbody collision prevention assembly, in accordance with an embodiment of the present disclosure.

FIG. 3 illustrates a second-front view of the underbody collision prevention assembly, in accordance with an embodiment of the present disclosure.

FIG. 4 illustrates a perspective view of a roller equipped on a shaft, in accordance with an embodiment of the present disclosure

FIG. 5 illustrates a flow chart of a method of retrofitting the underbody collision prevention assembly to the vehicle, in accordance with an embodiment of the present disclosure.

### DETAILED DESCRIPTION

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, “comprising of” or any other variations thereof, are intended to cover a non-exclusive inclusions, such that a system or a device that comprises a list of components or steps does not include only those components or steps but may include other components or steps not expressly listed or inherent to such setup or device. In other words, one or more elements in a system or apparatus proceeded by “comprises… a” does not, without more constraints, preclude the existence of other elements or additional elements in the system or apparatus.

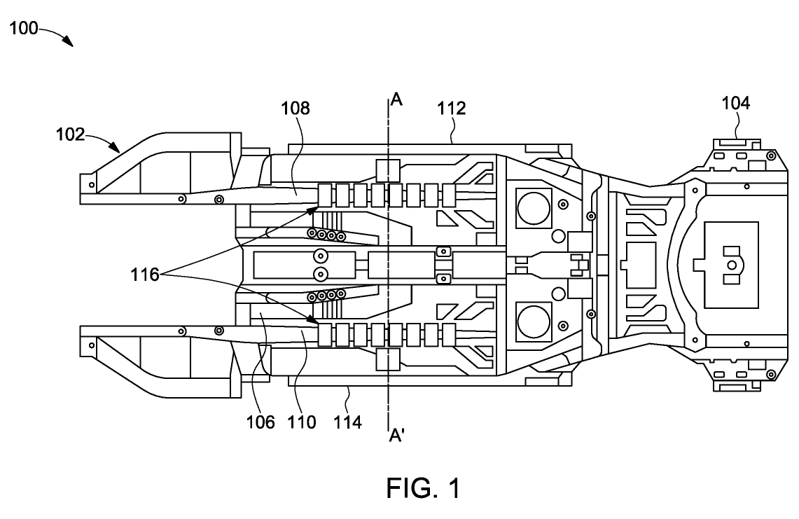

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-5. It is to be noted that the system may be employed in any vehicle including but not limited to a commercial vehicle, a passenger vehicle, a utility vehicle, heavy commercial vehicles, and any other transportable machinery. For the sake of clarity, the vehicle is not disclosed.

As explained earlier, the underbody of the vehicle is prone to various damages due to collision with the obstacle. Further, the underbody of the vehicle may be required to be protected from such collisions to prevent damage to vital components coupled to the chassis. Therefore, an underbody collision prevention assembly is disclosed. The assembly may be configured to absorb the impact of the collision by preventing direct collision of the underbody with the obstacle on the road.

Referring to FIG. 1, a bottom view 100 of an underbody 102 of a vehicle (not shown) is illustrated, in accordance with an embodiment of the present disclosure. The underbody 102 may be coupled to a chassis 104 of the vehicle. The underbody 102 may be disposed underneath the chassis 104 of the vehicle. The chassis 104 may include a portion 106 defining a floor section of the underbody 102. The portion 106 may include a pair of long runs 108, 110 (collectively referred to as the long run 108 and 110) formed along a length of the portion 106. For example, the long runs 108, and 110 may include a first long run 108, and a second long run 110 disposed opposite to the first long run 108. Further, the portion 106 may include a pair of side sills 112 and 114 disposed opposite to each other, and may be configured to reinforce the portion 106 of the underbody 102. It is to be noted, the underbody 102 may be prone to damage from an obstacle protruding from the road such as at least one road bump, a speed bumper, and the like.

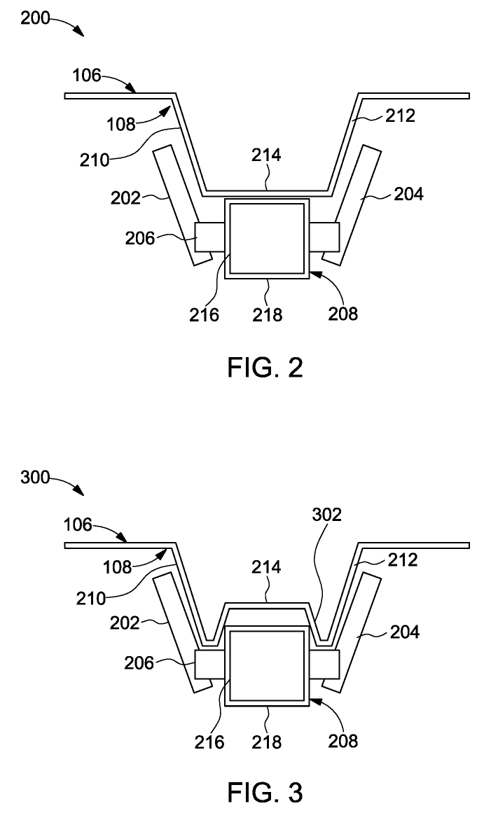

Therefore, an underbody collision prevention assembly 116 may be coupled to the underbody 102 of the vehicle. For example, the first long run 108, and the second long run 110 of the portion of the chassis 104 may be adjoined to the underbody collision prevention assembly 116. The underbody collision prevention assembly 116 may be installed within a cross-section A-A’ of the portion 106. The underbody collision prevention assembly 116 may be configured to prevent collision of the underbody 102 with obstacle by preventing a direct contact of the underbody 102 with the obstacle. Further, the underbody collision prevention assembly 116 may be accommodated to the first long run 108 and the second long run 110. This is explained in greater detail in conjunction with FIGS. 2-3.

In an embodiment, referring to FIG. 2, which illustrates a first-front view 200 of the underbody collision prevention assembly 116, in accordance with an embodiment of the present disclosure. FIG. 2 is explained in conjunction with FIG. 1. In an embodiment, the underbody collision prevention assembly 116 may be coupled to the underbody 102 of the vehicle. The underbody collision prevention assembly 116 may include a pair of support brackets 202, and 204 configured to be fixated to the first long run 108 of the portion 106 of the chassis 104 in the underbody 102. The underbody collision prevention assembly 116 may include a plurality of shafts 206 accommodated within the pair of support brackets 202, and 204. Further, the underbody collision prevention assembly 116 may include a roller 208 equipped on each shaft 206. The roller 208 may be configured to roll about a central axis on an obstacle on a road upon a contact of the underbody 102 with the obstacle.

As apparent from FIG. 2, the plurality of shafts 206 may be disposed beneath the first long run 108. The first long run 108 may include a first wall 210 and a second wall 212 disposed opposite to the first wall 210. Further, the first long run 108 may include a base 214 disposed transpose to the first wall 210 and the second wall 212. Accordingly, the pair of support brackets 202, and 204 may be fixated to the first wall 210 and the second wall 212 of the first long run 108 by using fastening methods commonly known in the art. By way of example, the pair of support brackets 202, and 204 may define a predefined length corresponding to length of the first long run 108. Further, the pair of support brackets 202, and 204 may be configured to accommodate the plurality of shafts 206 therebetween using the fastening methods commonly known in the art. By way of example, the pair of support brackets 202, and 204 and the plurality of shafts 206 may be adjoined together to accommodate the first wall 210, the second wall 212, and the base 214. Therefore, the long run 108, and 110 may be secured from the direct contact with the ground during collision.

To elaborate further, the roller 208 may be equipped on each shaft 206 and may be configured to be accommodated underneath the base 214. Hence, the roller 208 may be disposed offset from the ground and portion 106 of the chassis 104. For example, when the vehicle passes through the obstacle in the road, each roller 208 may be configured to roll about the central axis of each shaft 206 on the obstacle. By virtue of the rolling motion of the roller 208, an impact of collision exerted on the long run 108 during the collision may be dissipated. Consequently, the distortion of the long run 108, and 110 may be prevented and structural integrity of the underbody 102 may be maintained. However, due to regular wear-and-tear and contact between roller 208 and the obstacle, the plurality of rollers 208 may be prone to damage and generation of unwanted noises. Therefore, each roller 208 may include a periphery 216 and an impact resistance material 218 may be layered on the periphery 216 to secure the roller 208 from the regular wear and tear. By way of example, the impact resistance material may include but not limited to, acrylonitrile butadiene styrene (ABS), high-density polyethylene (HDPE), polyethylene terephthalate glycol, polytetrafluoroethylene, and the like.

In an embodiment, each shaft 206 from the plurality of shaft 206 may be either fixedly accommodated within the pair of support brackets 202, and 204 or rotatably accommodated within the pair of support brackets 202, and 204. For example, when each shaft 206 may be fixedly accommodated within the pair of support brackets 202, and 204, each shaft 206 and each roller 208 may roll about the central axis of the shaft 206 on the obstacle on the road.

Similarly, when each shaft 206 may be rotatably coupled to the pair of support brackets 202, and 204, the roller 208 may be fixedly equipped on each shaft 206. Therefore, the plurality of shafts 206 and the plurality of rollers 208 equipped thereon may be configured to roll about the central axis of the shaft 206 on the obstacle on the road upon a contact of the underbody 102 with the obstacle. Thereby, the impact of the collision may be dissipated by the rolling motion of the roller 208.

In an embodiment, referring to FIG. 3, which illustrates a second-front view 300 of the underbody collision prevention assembly 116, in accordance with an embodiment of the present disclosure. FIG. 3 is explained in conjunction with FIGS. 1 and 2. As explained earlier, each long run 108, 110 may include the first wall 210, the second wall 212, and the base 214. In an alternative embodiment, the base 214 may define an extruded portion 302 formed in the long run 108, and 110 and configured to accommodate the roller 208.

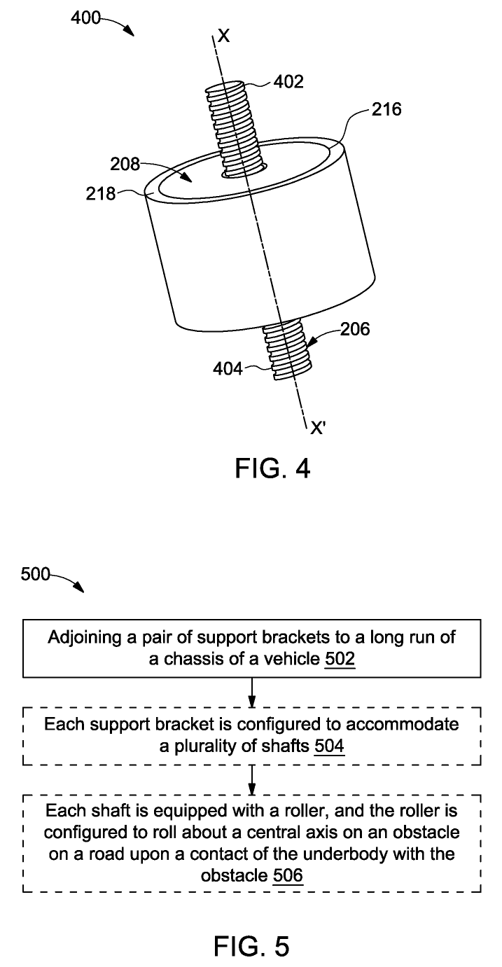

To elaborate further, the pair of support brackets 202, and 204 and the plurality of shafts 206 may be adjoined together to accommodate the first wall 210, the second wall 212, and the base 214. The plurality of shafts 206 may be disposed beneath the base 214. Further, the roller 208 may be equipped on each shaft 206 and may be accommodated within the extruded portion 302. Hence, the plurality of rollers 208 may be disposed offset from the ground and the portion 106 of the chassis 104. Furthermore, each shaft 206 from the plurality of shafts 206 may be either fixedly accommodated within the pair of support brackets 202, 204 or rotatably accommodated within the pair of support brackets 202, 204. This is already explained in FIG. 2. Further, the assembly of the roller 208 is explained in greater detail in conjunction with FIG. 4.

Now, referring to FIG. 4, which illustrates a perspective view 400 of the roller 208 equipped on the shaft 206, in accordance with an embodiment of the present disclosure. As explained earlier, the plurality of shafts 206 may be accommodated within the pair of support brackets 202, and 204. Further, each roller 208 may be equipped on each shaft 206.

In an embodiment, the shaft 206 may include a first end 402 and a second end 404 disposed opposite to the first end 402. For example, the first end 402 may be adjoined to the support bracket 202 using fastening methods commonly known in the art, and the second end 404 may be adjoined to the support bracket 204 using fastening methods commonly known in the art. By way of example, the shaft 206 may be a threaded shaft. As apparent from FIG. 4, a central axis X-X’ may pass through the shaft 206. Accordingly, the plurality of rollers 208 may roll about the central axis X-X’ in response to the contact with the obstacle. Additionally, the periphery 216 of the roller 208 may be layered with the impact resistance material 218 to secure the roller 208 from wear and tear. This is already explained in greater detail in FIG. 2.

In an embodiment, referring to FIG. 5, which illustrates a flow chart 500 of a method of retrofitting the underbody collision prevention assembly 116 to the vehicle, in accordance with an embodiment of the present disclosure. It is to be noted that the underbody collision prevention assembly 116 may be retrofitted to the chassis 104 of the vehicle by using fastening methods commonly known in the art. At step 502, adjoining, the pair of support brackets 202, and 204 to the long run 108, 110 of the chassis 104 of the vehicle. At step 504, each support bracket 202, and 204 may be configured to accommodate the plurality of shafts 206. At step 506, each shaft 206 may be equipped with the roller 208. Further, the roller may be configured to roll about the central axis (X-X’) on the obstacle on the road upon the contact of the underbody 102 with the obstacle. This is already explained in conjunction with FIGS. 1-4.

As will be appreciated by those skilled in the art, the assembly described in the various embodiments discussed above are not routine, or conventional or well understood in the art. Thus, the disclosed assembly try to overcome the relevant problem of damages to the components coupled to the underbody of the vehicle. The assembly may be disposed offset from the ground and the pair of long runs. Therefore, the direct contact of the underbody with the obstacles may be eliminated. Consequently, the structural integrity of the underbody may be maintained. Therefore, the risk of fuel leakage and suspension damage may be prevented. Further, the impact of collision may be dissipated by the plurality of rollers equipped on the corresponding shaft disposed between the pair of support brackets. Further, the assembly offers cost savings to manufacturers and customers. Also, the components of the assembly may be easily incorporated into upcoming vehicles and existing vehicles with slight modifications.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An underbody collision prevention assembly for a vehicle, comprising:
a pair of support brackets configured to be fixated to a long run of a portion of a chassis in the underbody of the vehicle;
a plurality of shafts accommodated within the pair of support brackets; and
a roller equipped on each shaft, wherein the roller is configured to roll about a central axis on an obstacle on a road upon contact of the underbody with the obstacle.

2. The underbody collision prevention assembly of claim 1, wherein an impact resistance material is layered on a periphery of the roller.

3. The underbody collision prevention assembly of claim 1, wherein each shaft is either:
fixedly accommodated within the pair of support brackets; or
rotatably accommodated within the pair of support brackets.

4. The underbody collision prevention assembly of claim 1, wherein the long run comprises:
an extruded portion formed in the long run configured to accommodate the roller.

5. A method of retrofitting an underbody collision prevention assembly to a vehicle, comprising:
adjoining, a pair of support brackets to a long run of a chassis of the vehicle, wherein:
each support bracket is configured to accommodate a plurality of shafts; and
each shaft is equipped with a roller, wherein the roller is configured to roll about a central axis on an obstacle on a road upon contact of the underbody with the obstacle.

6. The method of claim 5, comprising:
layering, an impact resistance material on a periphery of the roller.

7. The method of claim 5, wherein each shaft is either:
fixedly accommodated within the pair of support brackets; or
rotatably accommodated within the pair of support brackets.

8. The method of claim 5, comprising:
accommodating the roller in an extruded portion formed within the long run.

9. A chassis of a vehicle, comprising:
a long run of a portion of a chassis in an underbody of the vehicle;
a pair of support brackets configured to be fixated to the long run;
a plurality of shafts accommodated within the pair of support brackets; and
a roller equipped on each shaft, wherein the roller is configured to roll about a central axis on an obstacle on a road upon a contact of the underbody with the obstacle.

10. The chassis of claim 9, comprising:
an impact resistance material is layered on a periphery of the roller.

11. The chassis of claim 9, wherein each shaft from the plurality of shafts is any one of:
fixedly accommodated within the pair of support brackets; or
rotatably accommodated within the pair of support brackets.

12. The chassis of claim 9, wherein the long run comprises:
an extruded portion formed in the long run configured to accommodate the roller.

13. A vehicle, comprising:
a portion of a chassis in an underbody of the vehicle, comprising:
a long run;
a pair of support brackets configured to be fixated to the long run;
a plurality of shafts accommodated within the pair of support brackets; and
a roller equipped on each shaft, wherein the roller is configured to roll about a central axis on an obstacle on a road upon a contact of the underbody with the obstacle.

14. The vehicle of claim 13, wherein an impact resistance material is layered on a periphery of the roller.

15. The vehicle of claim 13, wherein each shaft is either:
fixedly accommodated within the pair of support brackets, or
rotatably accommodated within the pair of support brackets.
